(19) United States
(12) Patent Application Publication
(10) Pub. No.: US 2012/0325225 A1
(43) Pub. Date: Dec. 27, 2012

(54) SWING BITE MINI MOUTHPIECE

(76) Inventor: Trevor Scott Small, White Rock (CA)

(21) Appl. No.: 13/168,533

(22) Filed: Jun. 24, 2011

(51) Int. Cl. A61C 5/14

(52) U.S. Cl. 128/862; 128/861

(57) ABSTRACT

A miniaturized mouthpiece for repositioning the user's mandible, thereby creating an edge to edge relationship of the user's anterior teeth, without covering or extending to the user's posterior teeth. This miniaturized mouthpiece may be formed from a substantially trapezoidal mouthpiece blank having major and minor sides that are substantially parallel to one another. These major and minor sides may be connected by two equal length non-parallel sides. This blank will typically have a gently curved and raised contact area that follows the curvature of the user's anterior dental arches. The mouthpiece blank will often be made of a thermoplastic material, so that upon application of heat, the blank can be deformed around the user's maxillary central incisors and often the user's maxillary lateral incisors as well, thus creating a mouthpiece that does not cover the user's molars or premolars, yet which creates an interocclusal gap when worn.

### BACKGROUND OF THE INVENTION

1. Field of the Invention

This invention is in the field of miniature mouthpieces for enhancing athletic performance by repositioning the user's mandible.

2. Description of the Related Art

Mouthpieces and mouthguards are often used in sports to prevent injury to the teeth, as well as to help treat temporomandibular joint disorders (TMD). Many athletes, in sports such as baseball, basketball, boxing, football, hockey, rugby, skiing, water polo and the like wear mouthguards to both help protect the teeth and reduce the incidence of concussion. Such considerations are discussed in the book by Julian Hodges entitled “Mouthguards & Sport Safety: No-Nonsense Resource for Everyone Who Recommends or Should Wear a Mouthguard”, published in 2009 by Good Innovations Pty Ltd., Avalon, Australia.

Examples of such prior art mouthguards include Westerman, U.S. Pat. No. 6,036,487, who taught the utility of making mouthguards out of orally acceptable plastics materials containing a plurality of airtight cavities. Other examples of prior art in this area include Ackervall, US patent application 2009/0038624, who taught the use of “U” shaped thermoplastic materials formed from perforated plastic sheets.

Prior art mouthguards generally wrapped around both the user's anterior teeth (i.e. incisors) and posterior teeth (i.e. molars and premolars). In particular, especially for athletic applications, covering the user's posterior teeth (molars) was considered to be advantageous because such mouthguards could help cushion or reduce the transmission of shocks from the user's lower (Mandibular) molars to the user's upper (Maxillary) molars, and thus help prevent mouth and even brain damage under high impact situations.

### BRIEF SUMMARY OF THE INVENTION

The invention is based, in part, on the insight that although protecting the user's molars by placing material between the molars is indeed advantageous under certain situations, in other situations, actually placing material between the molars it is less advantageous and/or unnecessary. Indeed other methods of providing a space between the molars may suffice. According to the invention, for such situations, it can be advantageous to use a “mini” mouthpiece that is configured to primarily or exclusively work with the user's anterior central and lateral incisors, and not to cover either the user's molars or premolars.

Thus, in some embodiments, the invention may be a miniaturized mouthpiece for repositioning the user's mandible, thereby creating an edge to edge relationship of the user's anterior teeth, which are the user's most anterior two or four teeth (central incisors only or central incisors and lateral incisors). The invention's miniaturized mouthpiece can reposition the user's mandible so that the user's anterior teeth are aligned atop of each other, without covering or extending to the user's posterior teeth. The bite is edge to edge. Once the user has the mouthpiece in the engaged position, it creates an interocclusal (space) of about 0.5-8 mm between the user's posterior teeth (e.g. molars). In other words, when worn, the device creates an interocclusal gap that does not allow the user's molars to touch each other. In some embodiments, this miniaturized mouthpiece may be formed from a substantially trapezoidal mouthpiece blank having major and minor sides that are substantially parallel to one another. These major and minor sides may be connected by two equal length non-parallel sides, thus forming a roughly trapezoidal structure. This blank will typically have a contact area, of which at least portions of this area will run in a substantially parallel direction to the blank's major and minor sides. The contact area is usually gently curved in order to follow the curvature of the user's anterior upper and lower dental arches. The curve is based on the Curve of Monson, which is described as a portion of a sphere having a radius of about 101 mm (this radius varies somewhat, with an SD of approximately 24 mm, according to the size of the user's jaw, thus the 2SD range for this radius would be approximately 50 to 150 mm). This contact area will generally be located in the central portion of the mouthpiece blank between the major and minor sides of the blank. The blank will often be made of a thermoplastic material, so that upon application of heat, the blank can be deformed around the user's maxillary incisors.

This contact area will be designed to accommodate the user's anterior teeth, and will generally have oppositely disposed top and bottom areas with sufficient widths to accommodate the user's maxillary and mandibular anterior teeth. The contact area will have a slight curve to permit contact of the user's anterior teeth, which are generally in an arch form. These areas will be raised platforms of the device which the teeth will contact. In some embodiments, the blank may also have a plurality of perforations having dimensions substantially smaller than the dimensions of a tooth.

### BRIEF DESCRIPTION OF THE DRAWINGS

FIG. 1 shows an overview of one embodiment of the invention's miniature mouthguard blank.

FIG. 2 shows how the invention's miniature mouthguard blank may have a substantially trapezoidal structure.

FIG. 3 shows both front and side views of the invention's miniature mouthguard blank, showing the raised contact area.

FIG. 4 shows some of the typical dimensions of the invention's miniature mouthguard blank.

FIG. 5 shows how the invention's miniature mouthguard blank may be configured into a folded shape to fit around the user's anterior teeth.

FIG. 6 shows a schematic side view of how the miniature mouthguard, when worn, works with the user's jaw bone and anterior and posterior teeth to provide an interocclusal gap between the user's posterior teeth.

FIG. 7 shows a close up of the bite region of the mouthguard, showing one embodiment where the top is molded to the teeth and is retentive, and the bottom is molded to the teeth when formed and acts as an alignment channel when engaged.

### DETAILED DESCRIPTION OF THE INVENTION

As previously discussed, in one embodiment, the invention may be a miniaturized mouthpiece for repositioning the user's mandible, thereby creating an edge to edge relationship of the user's anterior teeth. Thus the invention will reposition the mandible so that the user's maxillary and mandibular anterior teeth are aligned atop of each other, while at the same time, the invention will not cover or extend to the user's posterior teeth (e.g. molars). By virtue of forcing the anterior teeth somewhat apart, and the fact that the anterior teeth and posterior teeth are of course connected by the user's jaw, the invention will also operate to create a 0.5-8 mm interocclusal gap or space in the posterior teeth. Generally, the invention will only cover the user's incisors.

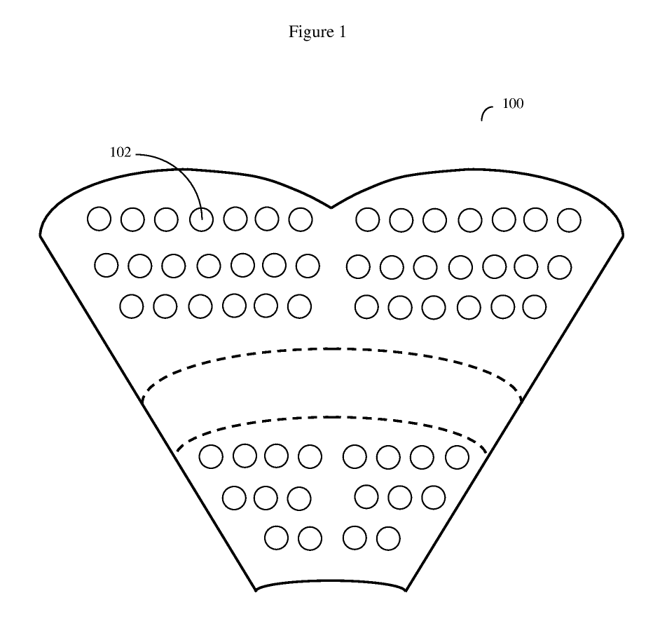

The invention's mouthpiece blank will generally create a mouthpiece in a curved, three dimensional configuration that will cover the user's maxillary anterior teeth in use. This mouthpiece will be formed from a substantially trapezoidal blank material, often made from an oral compatible material about 0.5-5 mm thick, which is shown in FIG. 1 (100). In an optional embodiment, this blank material may have a plurality of perforations (102). These perforations will typically be cylindrical in nature, with a diameter substantially smaller than the dimensions of the user's teeth, often on the rough order of 0.5-2 mm. These perforations will often extend completely through the blank, thus creating a hollow hole, through which saliva may flow.

The blank will have overall dimensions designed to fit, when folded into a three dimensional shape, around the user's maxillary anterior teeth (e.g. the user's central incisor teeth and optionally the user's central incisor teeth and the user's lateral incisor teeth) and be worn comfortably in the mouth.

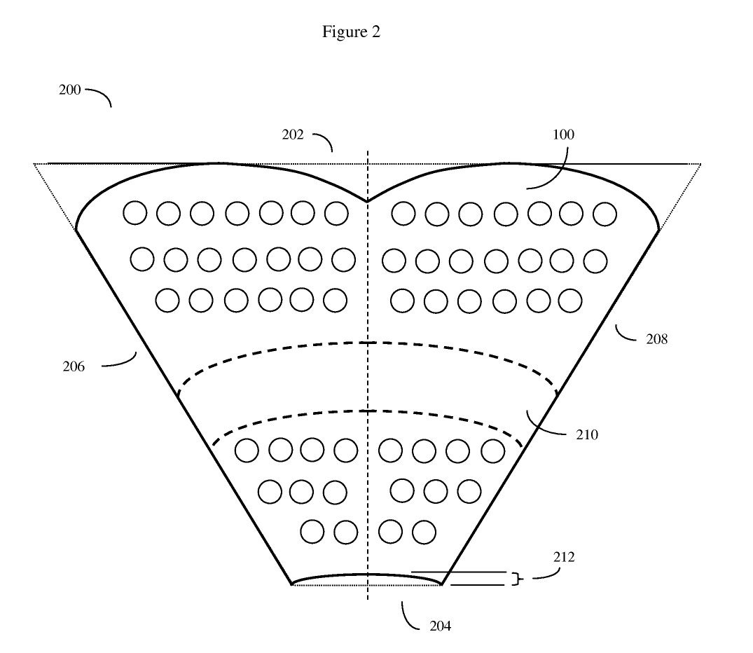

As shown in FIG. 2, this blank (100) generally both roughly resembles a trapezoid, and also generally fits within trapezoid (200). The substantially trapezoidal blank (100) will have major (202) and minor (204) sides that are substantially parallel to one another. These major (202) and minor (204) sides are connected by two equal length non-parallel sides (206), (208). Although the major sides and the minor sides need not be straight, and instead may be formed from one or more curved surfaces, the outer boundary of the sides will still generally fit within a trapezoidal outline (200).

The blank (100) will further have a contact area (210) that runs substantially parallel to the major (202) and minor sides (204), and disposed in the blank (100) in-between the major and minor sides (202), (204). This contact area is designed to accommodate the user's anterior teeth, and will generally have oppositely disposed top and bottom areas with sufficient widths to accommodate the tips of the user's maxillary central incisors and optionally lateral incisors on one side, and the tips of the user's mandibular central incisors and optionally lateral incisors on the other side. This gently curved shape thus accommodates the anterior portion of the user's teeth. The curve is based on the Curve of Monson, which is described as a portion of a sphere with a radius generally varying between approximately 50 and 150 mm, often approximately 101 mm, with an SD of 24 mm, again varying somewhat with the user's particular jaw size and shape. In for some unusual jaws, +/−3SD limits for the Curve of Monson may be required.

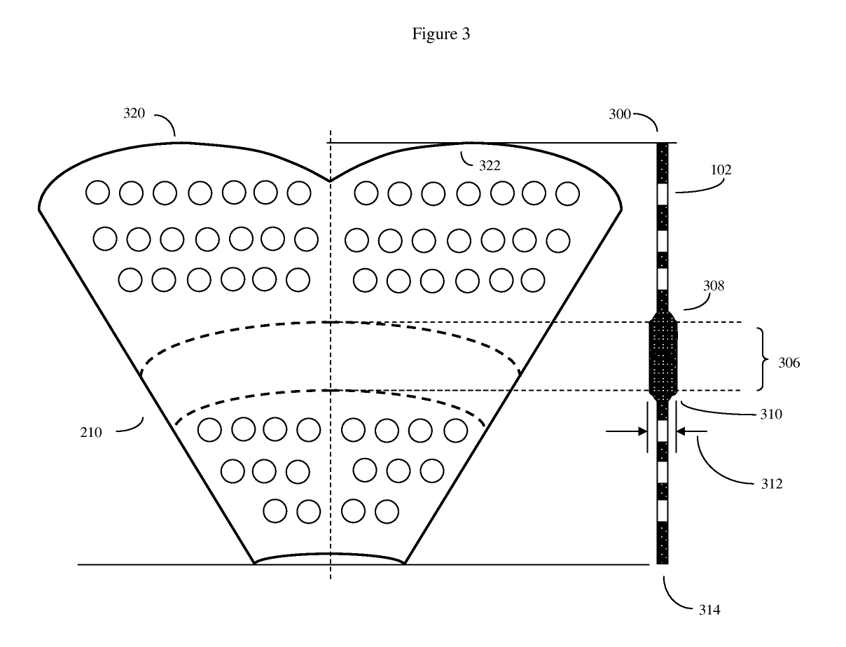

As shown in FIG. 3, which shows a side view of the blank (300), the contact area (210) will have a material (312) which is generally thicker than the remainder of the device, usually thick enough to cause an interocclusal gap of between 0.5 to 8 mm when the device is worn. The contact area (210), will generally have a width (306) of between 1-10 mm, and may have abrupt or rounded edges (308), (310). This width (306) is designed so that the device, when three dimensionally folded around the user's maxillary anterior teeth, will thus form an area that can accommodate the width of the user's maxillary and mandibular anterior teeth (incisors).

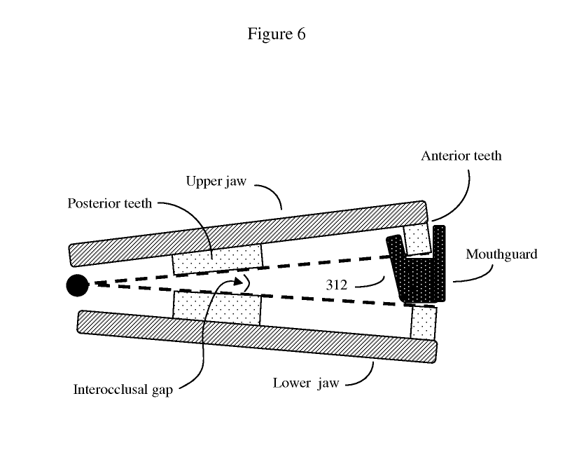

The thickness of the contact (312) area will generally be at least 0.5-4 mm thicker than the rest of the blank (314), and may be up to 1 cm thicker. Thus if the blank is generally 3 mm thick (314), then the thickness (312) of the contact area will generally be at least 3.5-9 mm. Thus, as previously discussed, in some embodiments, the thickness of the contact area will be thick enough so that the device when worn will cause the user's molars to be positioned with an interocclusal gap of between 0.5 to 8 mm. In this way, the device helps to minimize lower molar to upper molar shock transfer, while not actually providing any material between the molars. This is shown in more detail in FIG. 6.

To provide this interocclusal gap, it may be necessary to optimize the thickness of the contact area (312) to different values depending upon the characteristics of the user's mouth. Thus in some embodiments, some fitting may be required. In particular, it may be necessary to select or adjust the thickness of the contact area so as to create a 0.5 to 8 mm high interocclusal gap between the molars of a given user.

In some embodiments, the major side of the blank, rather than being straight, will be composed of one or more curved regions, such as two equal length connected arcs (320), (322). In this particular embodiment, a line drawn through the uppermost portion of both arcs will be substantially parallel to the blank's minor side, as shown in FIG. 2 (202), (204). This type of equal length, connected arcs, embodiment can be useful because the two arcs help the mouthguard, when folded into its operating three dimensional shape, to better conform to the gum line of anterior portion of the user's upper jaw. Other shapes may also be used for this region as well, however. The major side of the blank is often termed the labial or “lip side” of the device.

The minor side of the device (204), which in use will be folded into a position that is facing the tongue (lingual) side of the user's mouth, need not be straight either. Generally the regions where the minor side (204) contacts the non-parallel sides (206), (208) may often be gently rounded to avoid creating sharp corners that might cause mouth irritation. In some embodiments, the minor side (204) may be gently rounded or curved (212) so as to create an arc or indentation between 1-5 mm deep. However generally when the minor side (204) is an arc, it will be an arc with rounded edges at the region where the minor side (204) contacts the equal length non-parallel sides (206), (208), and often a line drawn through both rounded edges will be substantially parallel to the major side (202).

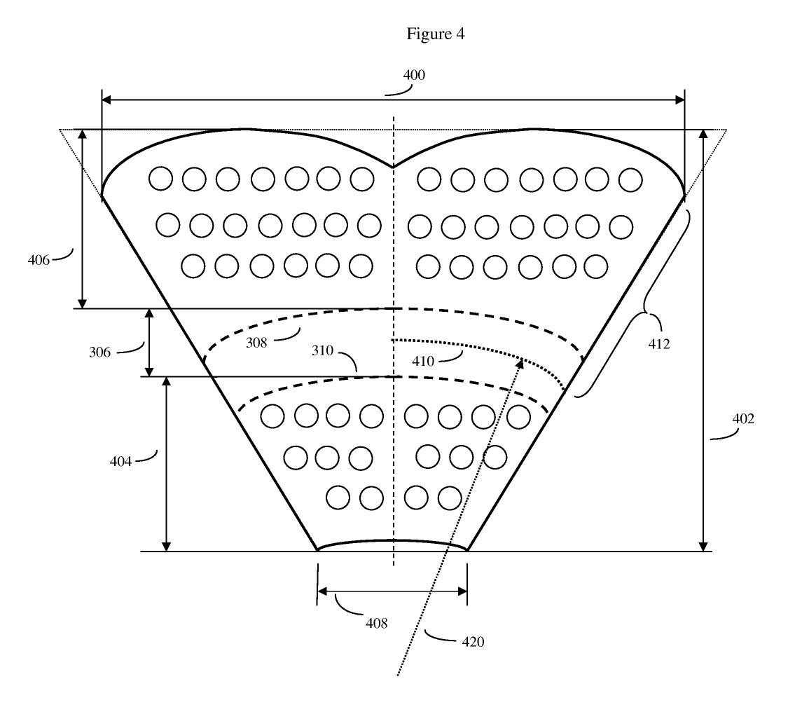

The dimensions of the mouthpiece blank are further shown in FIG. 4. Typically the width (400) of the blank at the major side is between 25 and 50 mm, and the distance (402) between the major and minor side is between 20 and 40 mm.

The length (404) between the minor side (204) and the lower side of the contact area (310) is often between about 5-25 mm. Similarly, the length (406) between the major side (202) and the upper side of the contact area (308) is often between 5-25 mm as well. The length (408) of the minor side is often between 5 and 15 mm long.

Note that the center of the contact area (410) is positioned in the central region of the blank at distances (412) ranging between ⅓ to ⅔ of the distance between the major and minor sides (202), (204). As previously discussed, the contact area (210) will generally have a width (306) between 1-10 mm (often 2-5 mm), and the overall length of the contact area is usually long enough to accommodate the user's central incisors and often the user's lateral incisors as well. This will vary according to the shape and size of the user's teeth, but will usually be between about 10 to 35 mm long. The radius of this contact area (420) at the center (410) will vary according to the curve of Monson, as previously discussed, typically between 50 to 150 mm.

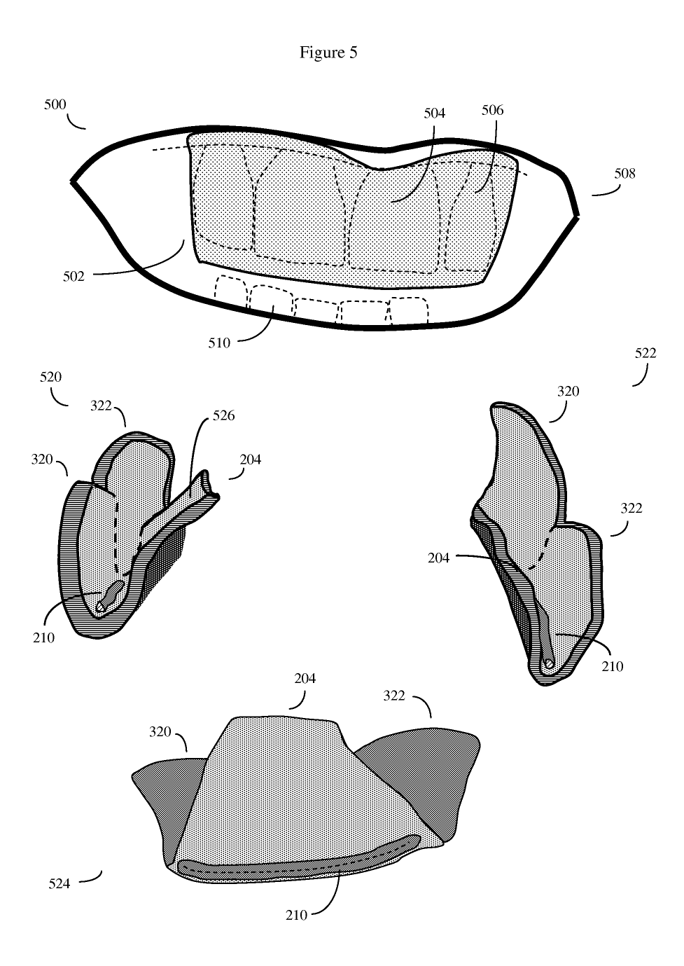

FIG. 5 shows how the invention's miniature mouthguard blank may be configured into a folded shape to fit around the user's anterior teeth.

FIG. 5 (500) shows the mouthguard configured into a folded shape (502), and fitting around the maxillary central incisors (504) and lateral incisors (506). The outline of the user's mouth and lips (508), as well as some of the user's lower anterior teeth (510) are also shown.

FIG. 5 (520, 522, 524) shows the folded form of the mouthguard from various rotated perspectives, showing the relative positions of the major arcs (320), (322) of the major side, the positions of the minor side (204), and the position of the contact area (210).

Here, to facilitate the folding process, the mouthpiece blank (100) can be made from a thermally flexible orally acceptable material, such as polycaprolactone, that is capable of being softened in hot water (˜70° C.), and then bent to conform to the mouth and teeth of a user. When cooled down to body temperature (˜37° C.), the material can then maintain a rigid configuration.

When the blank is configured into a folded shape to fit about the user's anterior teeth in this manner, the blank may either be held in place purely by friction, or else by a retentive gel which can be applied to the mouthpiece prior to placement into the mouth of a user.

Other orally compatible materials and other folding methods (e.g. molding based on mouth and teeth impressions) may also be used.

In some configurations, shown in FIG. 5 (526), when the blank (100) is configured into a folded shape that fits around the user's anterior teeth, it is useful to fold the portion of the blank proximate the minor side of the blank in an arc away from the major side of the blank so as to create a resting shelf for the user's bottom teeth when the mouthguard is worn in the disengaged position.

FIG. 6 shows a schematic side view of how the miniature mouthguard, when worn, works with the jaw bone and the anterior and posterior teeth to provide an interocclusal gap between the user's posterior teeth. In this respect, the user's jaw and teeth act like a lever, and the mouthguard, by providing force at the end of the lever (at the anterior teeth) helps keep the posterior teeth separated. In FIG. 6, the width of the mouthguard (312) is exaggerated, and some of the other dimensions are also distorted in order to better convey this lever concept.

In practice, the mouthguard blanks may be manufactured in a number of standard sizes, such as various standard sized blanks for adults and children. The blanks need not be made out of a single material, but rather may be a composite of two or more different materials. These two or more different materials may either be present as different layers (e.g. along the thickness of the mouthguard), or alternatively may be in various regions of the device, such as different types of materials on the major side of the device, minor side of the device, and in the central contact area of the device.

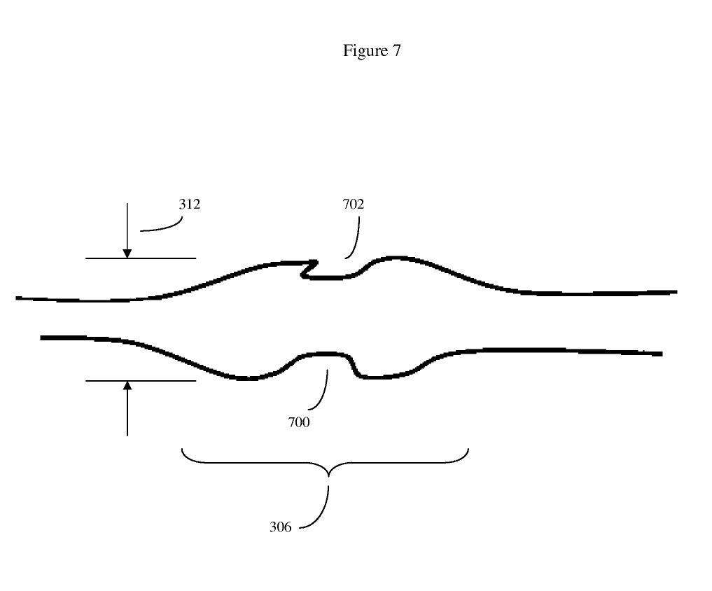

As shown in FIG. 7, in some embodiments, when formed, there may be two channels for the teeth to fit into (700), (702), such as a top (702) that is molded to the teeth and is retentive, and a bottom (700) that is molded to the teeth when formed and acts as an alignment channel when engaged.

In this embodiment, the top part of the contact area of the mouthpiece is formed with a top channel (702) that is molded to fit the user's upper anterior teeth, and is also configured to adhere to said upper anterior teeth. Further, the bottom part of the contact area (700) is formed with a bottom channel that is molded to fit the user's bottom anterior teeth. This channel (700) further acts as a mouthpiece alignment channel when, for example, the mouthpiece is engaged in the mouth of a user (500).

1. A miniaturized mouthpiece for repositioning the user's mandible, thereby creating an edge to edge relationship of the user's anterior teeth so that the user's anterior teeth are aligned atop of each other, said miniaturized mouthpiece not covering or extending to the user's posterior teeth beyond the lateral incisors, said mouthpiece comprising:
a substantially trapezoidal blank with major and minor sides that are substantially parallel to one another, said major and minor sides being connected by two equal length non-parallel sides;
said blank having a contact area disposed in said blank in-between said major and minor sides; and
said contact area having a width capable of accommodating the user's maxillary and mandibular anterior teeth;
said contact area further having a thickness capable of causing an interocclusal gap between the molars of said user.

2. The mouthpiece of claim 1, wherein said major side comprises two equal length connected arcs, such that a line drawn through the uppermost portion of both arcs will be substantially parallel to said minor side.

3. The mouthpiece of claim 1, wherein said minor side comprises one arc with rounded edges at the region where the minor side contacts the equal length non-parallel sides, such that a line drawn through both rounded edges will be substantially parallel to said major side.

4. The mouthpiece of claim 1, wherein the width of said blank at the major side is between 25 and 50 mm, the distance between the major and minor side is between 20 and 40 mm, and the thickness of said blank is between 0.5 and 5 mm.

5. The mouthpiece of claim 4, wherein the length of said minor side is between 5 and 25 mm.

6. The mouthpiece of claim 1, wherein the center of said contact area is positioned in the central region of said blank at distances ranging between ⅓ to ⅔ of the distance between said major and minor sides.

7. The mouthpiece of claim 1, wherein said contact area has a width of 1-10 mm, said contact area is curved in a concave manner with a radius between 50 to 150 mm, whose curvature towards the minor side of the blank, and in which the curvature of said contact area is substantially the same as the curvature of the user's dental arches.

8. The mouthpiece of claim 1, wherein the thickness of said contact area is sufficient, when the device is worn by a user, to cause an interocclusal gap (space) of between 0.5-8 mm between the user's posterior teeth.

9. The mouthpiece of claim 1, wherein said blank is made from a thermoplastic orally acceptable material. The mouthpiece of claim 11, wherein said orally acceptable plastic is a thermally flexible, orally acceptable material capable of being softened in hot water (˜70° C.) to conform to the mouth and teeth of a user, and then capable of maintaining a rigid structure when subsequently cooled to body temperature (˜37° C.).

10. The mouthpiece of claim 9, wherein when said blank is configured into a folded shape to fit about the user's upper anterior teeth, said mouthpiece is held in place with or without a retentive gel.

11. The mouthpiece of claim 11, wherein said plastic is polycaprolactone or other orally compatible thermoplastic.

12. The mouthpiece of claim 1, in which said blank is further configured into a folded shape that fits around the user's anterior teeth; and
wherein the portion of the blank proximate the minor side of said blank is further folded in an arc away from the major side of said blank so as to create a resting shelf for the user's bottom teeth when the mouthguard is worn in the disengaged position.

14. The mouthpiece of claim 1, wherein said contact area has a thickness of 1-4 mm, when worn in the edge to edge or engaged position.

15. The mouthpiece of claim 1, wherein the top part of said contact area is formed with a top channel that is molded to fit the user's upper anterior teeth, and is configured to adhere to said upper anterior teeth;
and wherein the bottom part of said contact area is formed with a bottom channel that is molded to fit the user's bottom anterior teeth and further acts as a mouthpiece alignment channel when said mouthpiece is engaged in the mouth of a user.

16. A method of adjusting the fitting of a miniaturized mouthpiece for repositioning the user's mandible, thereby creating an edge to edge relationship of the user's anterior teeth so that the user's anterior teeth are aligned atop of each other, said miniaturized mouthpiece not covering or extending to the user's posterior teeth beyond the lateral incisors, said mouthpiece having a contact area with a width capable of accommodating the user's maxillary and mandibular anterior teeth, and having a contact area thickness capable of causing an interocclusal gap between the molars of said user when said mouthpiece is worn, said method comprising:
adjusting or selecting the contact area thickness so as to create a 0.5 to 8 mm high interocclusal gap between the molars of said user when said mouthpiece is worn; and
configuring said mouthpiece into a folded shape to fit about the user's upper anterior teeth.
